(19) United States
(12) Patent Application Publication
(10) Pub. No.: US 2017/0327244 A1
(43) Pub. Date: Nov. 16, 2017

(54) DEVICE FOR TRANSPORTING A PASSENGER FROM DOOR TO DOOR

(71) Applicant: AIRBUS GROUP SAS, BLAGNAC (FR)

(72) Inventor: EMMANUEL BLANVILLAIN, ASNIERES (FR)

(73) Assignee: AIRBUS GROUP SAS, BLAGNAC (FR)

(21) Appl. No.: 15/525,047

(22) PCT Filed: Nov. 5, 2015
(86) PCT No.: PCT/FR2015/052989

§ 371 Date: May 5, 2017

(30) Foreign Application Priority Data
Nov. 7, 2014 (FR) 1460812

(51) Int. Cl. B64F 1/30

(52) U.S. Cl. CPC B64F 1/30

(57) ABSTRACT

A transportation device to transport a passenger from door to door. The device includes a platform equipped with wheels to move along the ground, and at least one private seat having a power source and a connector. The private seat is secured to the platform. The transportation device further includes a connected virtual reality unit that can construct a virtual environment for the passenger. Additionally, a method for transporting a passenger using the transportation device.

The present invention relates to a device for intermodal, door-to-door, private, mobile and connected transport.

The invention also relates to a method for transporting a traveler using the device according to the invention.

Air travel involves numerous constraints for journeys of short duration over short and medium distances, especially for business trips. Specifically, in order to attend a business meeting, a traveler traveling door-to-door must take numerous means of ground and air transport and interact with multiple interfaces in order to accomplish the procedures imposed (such as security checks, boarding procedures, etc.).

In the case of a conventional business trip, for example (referring to FIG. 2), a person must: go to the airport by taxi, public transport or car; move through the airport to find a counter or desk and check in; go to the inspection post in order to proceed to the security check; wait in a waiting room; go to the boarding gate; board the aircraft; and go to his or her seat inside the aircraft. When the aircraft lands, it is necessary to disembark from the aircraft, to leave the airport, to find a taxi or hire a car, and go to the location of the business meeting. After the meeting, the person must repeat all these steps in order to go home or to any other destination.

The journey is broken up and involves numerous disruptions for the traveler, which causes fatigue and stress and wastes time and productivity in relation to a sedentary day at work. Specifically, during such a journey, the only periods of time during which the traveler can take advantage of his or her waiting time in order to work or to entertain himself or herself are during the wait before boarding and during part of the flight, which represents only a minimal portion of the total duration of the trip. For example, a traveler can make profitable use of only 30% of the total journey time in the case of a journey by air within Europe.

By way of comparison, the solution of the high speed train is less fragmented and restores, proportionally, more useful time to the user for a journey of similar duration. Solutions making it possible to facilitate air travel have been proposed.

For example, certain airlines make services available to their passengers to accompany them and reduce the inconveniences mentioned above. The solutions comprise limousine, priority security check and boarding services, and provision, before boarding, of private rooms which are connected (for example, with an Internet access point), or else private jets.

However, these solutions which are intended only for high-end clientele serve only to limit the abovementioned constraints, or to minimize their impact in terms of time but reduce neither the number of interfaces nor the multiple interruptions during the traveler's trip.

An aim of the present invention is to remedy these drawbacks by providing a device able to make the journey completely seamless for the traveler and to restore to the latter all of the journey time so that the traveler can use the journey as he or she sees fit for his or her professional activities (telephone meetings, work on a computer etc.) and personal activities (rest, television, games etc.).

According to the invention, this aim is achieved by virtue of a device for intermodal, door-to-door, private, mobile and connected transport, able to accommodate the passenger throughout the duration of his or her journey, in a door-to-door manner.

The device for door-to-door transportation of a traveler according to the invention is noteworthy in that it comprises:
a platform provided with means for movement on the ground;
at least one private seat comprising an energy source and means of connection, this seat being fixed on the platform; and
connected virtual reality equipment able to reconstruct a virtual environment for the traveler.

This private and autonomous transportation device with connectivity thus allows the creation of a virtual “bubble” for the traveler by reconstructing a sedentary work and leisure environment, while said transportation device is still moving.

According to one advantageous mode of embodiment, the virtual reality system is integrated into and adjusted to the seat so as not to cause discomfort to the passenger even over a long period of time.

According to a preferred mode of execution, the audio system of the virtual reality equipment is configured so as not to cause inconvenience in the area around the traveler.

According to another characteristic arrangement, the transportation device according to the invention comprises a biometric identification system.

According to an advantageous mode of implementation, the transportation device according to the invention comprises a locker for receiving the personal effects of the traveler.

According to a preferred mode of embodiment, the baggage locker is disposed under the base of the seat of the transportation device according to the invention and is locked by the biometric identification system.

According to an advantageous mode of execution, the transportation device according to the invention comprises a retractable footrest.

According to another mode of embodiment, the transportation device according to the invention comprises a plurality of seats in order to transport several passengers making the same journey at the same time.

According to another example of execution, the transportation device according to the invention comprises two platforms, one being intended for transporting travelers, the other being intended for transporting the baggage of said travelers.

The invention also relates to a method for transporting a traveler using the device according to the invention.

The transportation method according to the invention is noteworthy in that it comprises the following steps:

a) dispatch of the transportation device according to the invention preloaded in a vehicle to the point of departure of the traveler;

b) identification of the traveler by way of the biometric system, placement of the baggage of the traveler in the locker provided for this purpose, seating on the seat, and activation by the traveler of the virtual reality system according to his or her wishes;

c) transportation of the device and of the traveler to an airport;

d) unloading of the device with the passenger therein from the terrestrial vehicle, and conveyance of said device to the interior of the airport toward a waiting room;

e) loading of the device with the passenger therein to the interior of the aircraft, the platform being fixed in the aircraft in the manner of a pallet;

f) after landing, unloading of the device with the passenger therein from the aircraft;

g) conveyance into the airport and loading of the device with the passenger therein into a terrestrial vehicle to be transported to the place of destination.

The method of the invention has the advantage of making the journey completely seamless from the point of view of the traveler such that the latter can take advantage of the whole journey time as he or she sees fit.

Thus when the traveler takes his or her place in this device, the journey takes place “around” him or her, i.e. without the traveler having any concerns and without being disturbed in any way from his or her activity. The logistics of transporting the seat from the origin (the door of the traveler's home, for example) to the traveler's destination (the meeting location, for example) is fully managed at all stages: on the ground, at the airport and in the aircraft itself.

This solution provides numerous advantages for the traveler since the latter can take advantage of all his or her journey time, door-to-door, since he or she will see the life and work rhythm of a sedentary day restored, thus making it possible to reduce fatigue and stress brought about by the journey, and to increase the productivity of the traveler. It is therefore a double advantage, both personal and professional, which is offered to the passenger.

The aims, features and advantages above, and further aims, features and advantages, will become more apparent from the detailed description which follows and from the appended drawings in which:

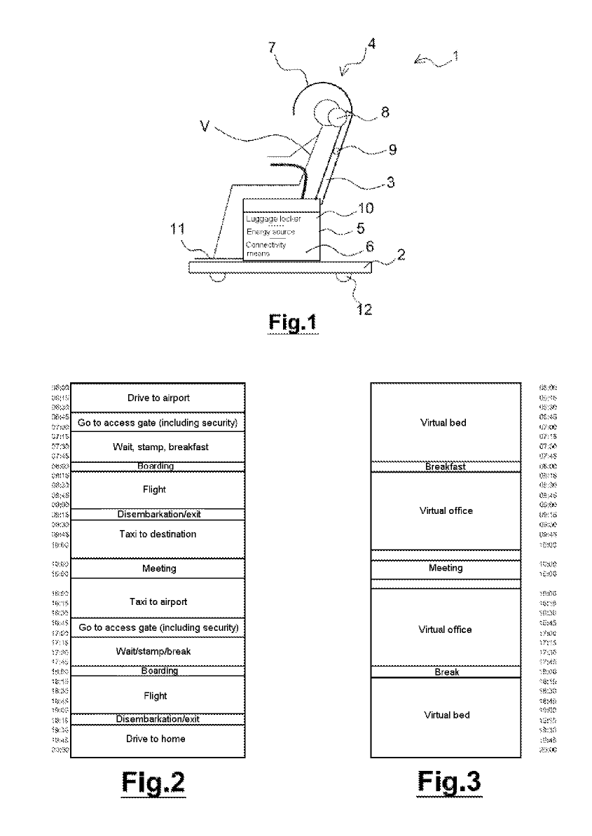

FIG. 1 is a schematic view of a transportation device according to the invention.

FIG. 2 is a time diagram representing the schedule of a current business trip.

FIG. 3 is a time diagram illustrating the schedule of a business trip with the use of a transportation device according to the invention.

Reference will be made to said drawings in order to describe advantageous examples of embodiment of the transportation device according to the invention, although these are in no way limiting.

The device 1 for door-to-door transportation of a traveler according to the invention comprises:
a platform 2;
at least one private seat 3 permanently fixed on said platform; and
virtual reality equipment 4 able to reconstruct a virtual environment for the traveler.

The platform 2 is equipped with means enabling movement thereof on the ground when it is pushed by a person or under the effect of a self-propelled traction device. For example, the means 12 for moving the platform 2 are wheels or casters.

This platform 2 is configured to receive a seat 3 which is permanently fixed. The seat may equally be fixed in a removable manner, in order to facilitate maintenance operations, for example.

The private seat 3 comprises, in a conventional manner, a base, a back, a head restraint, and armrests. It comprises means enabling it to be rendered autonomous. The seat contains the elements essential for rendering it autonomous, namely an energy source 5, for example an electrical energy source such as a battery, and connectivity means 6, preferably wireless.

The connected virtual reality equipment 4 comprises a visual headset 7 having a screen for displaying the virtual environment, and an audio system comprising an audio headset or headphones and a microphone, the latter preferably being configured so as not to produce a disturbance in the area around the traveler.

This virtual equipment is configured in order to provide the traveler with a work or leisure environment, by providing instruments for work or for leisure, respectively.

For example, in his or her environment referred to as a “virtual office”, the traveler can make use of a telephone, a computer, his or her email box, etc.

Advantageously, the transportation device according to the invention is further equipped with a keyboard and it comprises connection means, for example wireless, allowing the passenger to connect his or her own work equipment such as a laptop computer or a USB stick.

In his or her space referred to as a “virtual room”, the traveler can make use of leisure functions such as a television, films, games, etc.

In his or her space referred to as a “virtual bed”, the traveler can program a starry sky and relaxing music in order to sleep or to relax.

The traveler can also observe his or her environment with a space referred to as a “virtual exterior”, allowing the traveler to observe his or her real external environment via his or her virtual reality equipment. For example, through this space, the traveler can visualize the scenery outside of the aircraft, or else see the possibilities of services in the surrounding area (such as toilets, possibility of eating or drinking, etc.) which are on offer throughout the journey.

Preferably and advantageously, the virtual reality system 4 is integrated into the seat 3, for example at the level of the head restraint thereof, and is adjusted to said seat in such a way as not to cause the traveler any discomfort, even over a long period of time.

Preferably and advantageously, the transportation device 1 comprises a system 9 for biometric identification of the traveler.

This biometric identification system which is integrated into the seat 3, for example, makes it possible to register the traveler T and constitutes a system for identifying said traveler in order to proceed automatically to security checks at the airport.

This biometric identification system 9 also serves to protect the connection data of the traveler, for example by allowing only the traveler registered for the relevant seat to access the virtual reality equipment.

The transportation device according to the invention further comprises a locker 10 for receiving the personal effects of the traveler.

Preferably and advantageously, the baggage locker is disposed under the base of the seat of the transportation device according to the invention and is locked by the biometric identification system in such a way that the contents thereof can be accessed only by the traveler T registered for the relevant seat.

Advantageously, the transportation device according to the invention is provided with a control and management system (not depicted) able to manage the various functions and to supply the virtual reality device.

Advantageously, the transportation device according to the invention comprises a footrest 11. This footrest is retractable in order to reduce the size of the device.

The transportation device according to the invention has dimensions such that:
the size thereof is not greater than that of a business class seat on a medium-haul aircraft, so as not to reduce the number of seats in existing craft;
it can be easily loaded through the doors of an aircraft in such a way as to be suitable for aircraft which are already in service.

For example, the device according to the invention is 60 cm wide in order to allow it to be loaded through the doors of an aircraft, and 85 cm long in order to be loaded in a conventional existing aircraft.

According to another mode of embodiment, for transportation of several passengers making the same journey at the same time, the platform 2 of the transportation device according to the invention comprises a plurality of seats 3.

According to yet another mode of execution, the transportation device according to the invention comprises two platforms 2, one being intended for transporting a traveler and comprising all the abovementioned features in terms of connection, comfort and security, and the other being intended for transporting the baggage of said traveler, the two platforms being joined together or removably connected to one another.

Particular logistics are set up around this device and allow the latter and the passenger transported therein to be dispatched from the point of departure to the point of arrival of the journey, and this is achieved in a manner which is completely seamless for the traveler.

The method according to the invention is noteworthy in that it comprises the following steps:

a) dispatch of the transportation device 1 according to the invention preloaded in a terrestrial vehicle to the point of departure of the traveler (the traveler's home, for example);

b) identification of the traveler via the biometric system 9, placement of the baggage of the traveler in the locker 10 provided for this purpose, seating on the seat 3, and activation by the traveler of the virtual reality system 4 according to his or her wishes;

c) transportation of the device and of the traveler to an airport;

d) unloading of the device 1 with the passenger therein from the terrestrial vehicle, and conveyance of said device to the interior of the airport toward a waiting room; registration and the security check are unnecessary in this step because they were carried out in the step b), during identification of the passenger by the biometric system 9;

e) loading of the device 1 with the passenger therein to the interior of the aircraft, the platform 2 being fixed in the aircraft in the manner of a pallet;

f) after landing, unloading of the device 1 with the passenger therein from the aircraft;

g) conveyance into the airport and loading of the device with the passenger therein into a terrestrial vehicle to be transported to the place of destination.

The security procedures (such as scanning the traveler and baggage, for example) may be carried out either during loading thereof into the terrestrial vehicle, or in the airport by scanning the transportation device completely with its passenger and the passengers baggage. In all cases, the security check is completely seamless for the passenger.

Once the traveler has sat down in the step b), he or she is no longer concerned with the logistical details of his or her journey and, by virtue of the virtual reality system 4, can make use of all his or her journey time without interruptions from when the transportation device takes charge of the traveler in the step b), and this applies throughout the whole duration of his or her journey (see FIG. 3), in the manner of a sedentary day.

When the traveler has arrived, he or she disconnects from the virtual reality system 4 and recovers his or her baggage from the locker 10 in order to go to his or her meeting.

When the traveler has finished his or her meeting, the return journey can take place in the same manner by repeating the steps of the transportation method toward a new destination or toward the home of the traveler.

If the same device is used for the return journey as for the outward journey, the traveler sits directly in his or her seat without having to identify himself or herself again.

The traveler can disconnect from the virtual reality system 4 and leave his or her seat 3 at any time, provided that the external environment permits this, the personal connection data and baggage locker 10 of the traveler being secured by the biometric identification system 9.

The transportation device according to the invention may be applied in the same way to all types of terrestrial transport other than a personal road vehicle, such as trains and public transport etc., for example.

Moreover, the device and method for door-to-door transportation according to the invention are particularly suited to people with reduced mobility such as the elderly or the disabled.

1-9. (canceled)

10. A transportation device for door-to-door transportation of a traveler, comprising:
a platform equipped with wheels to move on the ground;
at least one private seat comprising an energy source and a connector, said at least one private seat is fixed on the platform; and
a connected virtual reality equipment configured to reconstruct a virtual environment for the traveler, the virtual reality equipment comprising an audio system configured so as not to produce disturbance in an area around the traveler.

11. The transportation device as claimed in claim 10, wherein the virtual reality equipment is integrated into and adjusted to said at least one private seat so as not to cause discomfort to the traveler.

13. The transportation device as claimed in claim 10, further comprising a biometric identifier.

14. The transportation device as claimed in claim 10, further comprising a locker to receive personal effects of the traveler.

15. The transportation device as claimed in claim 13, further comprising a baggage locker disposed under a base of said at least one private seat and locked by the biometric identifier.

16. The transportation device as claimed in claim 10, further comprising a retractable footrest.

17. The transportation device as claimed in claim 10, further comprising a plurality of seats to transport several passengers making same journey at same time.

18. The transportation device as claimed in claim 10, further comprising two platforms, a first platform to transport the traveler and a second platform to transport a baggage of the traveler.

19. A method for transporting a traveler using the transportation device as claimed in claim 10, comprising the steps of:
dispatching the transportation device preloaded in a first terrestrial vehicle to a point of departure of the traveler;
identifying the traveler via a biometric identifier, placing baggage of the traveler in a locker, seating on said at least one private seat, and activating the virtual reality equipment by the traveler;
transporting the transportation device and the traveler to a departure airport;
unloading the transportation device with the traveler therein from the first terrestrial vehicle, and conveying the transportation device to interior of the airport towards a waiting room;
loading the transportation device with the traveler therein to interior of an aircraft, the platform being fixed to the aircraft in a manner of a pallet;
after landing the aircraft in an arrival airport, unloading the transportation device with the traveler therein from the aircraft; and
conveying the transportation device into the arrival airport and loading the transportation device with the traveler therein into a second terrestrial vehicle to transport the transportation device with the traveler therein to a place of destination.
